(19) United States
(12) Patent Application Publication
(10) Pub. No.: US 2008/0065551 A1
(43) Pub. Date: Mar. 13, 2008

(54) AUTO-DETECTING AND DOWNLOADING LICENSED COMPUTER PRODUCTS

(75) Inventors: NIMA NIAKAN, ALAMO, CA (US); LINDY LO, MOUNTAIN VIEW, CA (US); SCOTT BAEDER, AUBURN, MA (US)

Correspondence Address: KENYON & KENYON LLP, RIVERPARK TOWERS, SUITE 600, 333 W. SAN CARLOS ST., SAN JOSE, CA, 95110, US

(73) Assignee: CADENCE DESIGN SYSTEMS, INC., SAN JOSE, CA (US)

(21) Appl. No.: 11/470,992

(22) Filed: Sep. 7, 2006

(51) Int. Cl. H04L 9/00

(52) U.S. Cl. 705/59

(57) ABSTRACT

In a system and method for automatically detecting licensed computer products, a license manager stores contract data indicating a customer and one or more computer products licensed to the customer by a license holder. A customer site is automatically checked for present computer products owned by the license holder. The licensed computer products are compared to the present computer products. In one embodiment, the computer products are software products, but they also may be hardware products.

### BACKGROUND OF THE INVENTION

This application is related to application Ser. No. 09/854,330, filed May 11, 2001, titled “Contract Management System,” the disclosure of which is incorporated herein in its entirety.

The present invention relates generally to the use of computer products, including hardware and software products, and, more specifically, the detection of unlicensed computer products.

Software customers are permitted to purchase licenses under a variety of portal based, self-service mechanisms. One method has a purchasing customer download a software application to a given server on his network and create a license key, which enables use of the application. To generate a license key, the customer must establish a portal-based session with a licensing service and, among other things, identify the software for which a license is sought, identify terms of the licenses (such as time period), and identify the machine on which the software will execute. The licensing service charges a license fee against a customer account and generates the license key. When the customer stores the license key in a specified location on the server, the downloaded software application will be enabled.

A software seller may offer a variety of licensing plans, many of which entail complicated software management processes. For example, under one such plan, a customer licenses a specified version of a specified application. A customer may not have purchased the right to an updated version of the software application if it becomes available during the term of his license. Other customers, by contrast, may be entitled to the newer releases of the software automatically. Further, additional customers may renew an old license and, in so doing, license an updated version of the software application without necessarily appreciating that the updated version is available.

In practice, customers license multiple software applications to be enabled on a common machine simultaneously. It can become cumbersome to require a customer to manually keep track of which applications are licensed on the machine and which versions of the applications are available at which times. Accordingly, there is a need in the art for a system that automatically detects which software applications and which versions of the application are licensed for use by a particular customer and automatically downloads and installs appropriate applications and versions thereof on a customer machine.

### BRIEF DESCRIPTION OF THE DRAWINGS

FIG. 1 illustrates a possible configuration of a computer system to act as a user terminal or server to execute the present invention.

FIGS. 2a-b illustrate embodiments of a system that may be used to implement the present invention.

FIG. 3 illustrates one embodiment of the data structure of the license manager.

FIGS. 4a-b illustrate alternate embodiments of transferring the independent software product from the seller to the customer once the license has been established.

FIG. 5 illustrates in a flowchart one embodiment of a method for automatically detecting software on a customer's terminal that does not conform with the licensing for that customer.

### DETAILED DESCRIPTION

In the inventive system and method for automatically detecting licensed computer products, a product management database stores contract data indicating a customer and one or more computer products licensed to the customer by a license holder. A customer site is automatically checked for present computer products owned by the license holder to determine whether there are discrepancies between the licensed computer products and the present computer products.

For convenience, throughout the specification, with reference to one embodiment, software products will be referred to. However, the applicability of the invention to licensed hardware as well as to licensed software should be understood. Accordingly, throughout the description and claims, “computer products” refers to either hardware or software.

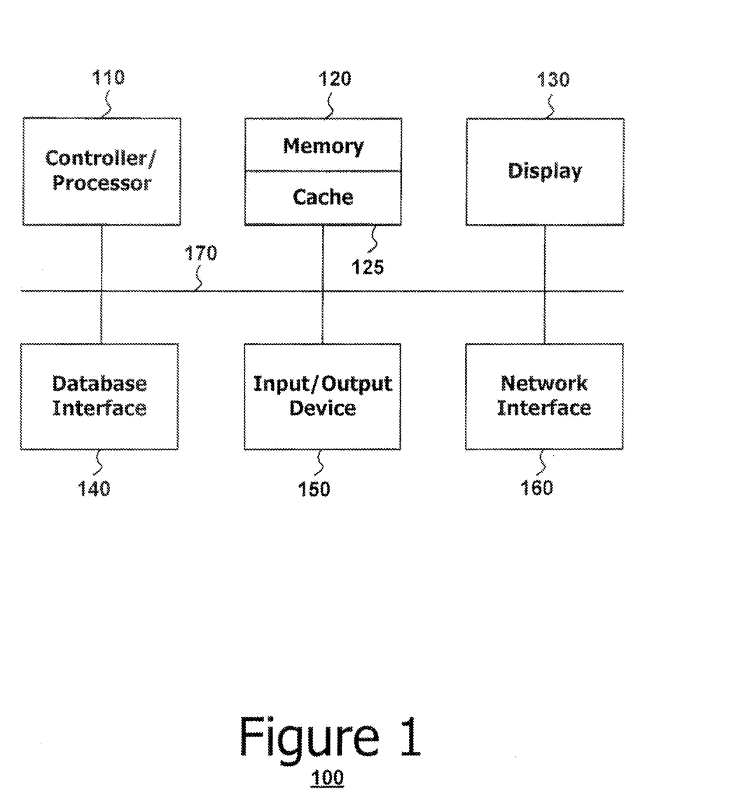

FIG. 1 illustrates a possible configuration of a computer system 100 to act as a user terminal or server to execute the present invention. The computer system 100 may include a controller/processor 110, a memory 120 with a cache 125, display 130, database interface 140, input/output device interface 150, and network interface 160, connected through bus 170.

The controller/processor 110 may be any programmed processor known to one of skill in the art. However, the decision support method can also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein can be used to implement the decision support system functions of this invention.

The memory 120 may include volatile and nonvolatile data storage, including one or more electrical, magnetic or optical memories such as a RAM, cache, hard drive, CD-ROM drive, tape drive or removable storage disk. The memory may have a cache 125 to speed access to specific data.

The Input/Output interface 150 may be connected to one or more input devices that may include a keyboard, mouse, pen-operated touch screen or monitor, voice-recognition device, or any other device that accepts input. The Input/Output interface 150 may also be connected to one or more output devices, such as a monitor, printer, disk drive, speakers, or any other device provided to output data.

The network interface 160 may be connected to a communication device, modem, network interface card, a transceiver, or any other device capable of transmitting and receiving signals over a network. The components of the computer system 100 may be connected via an electrical bus 170, for example, or linked wirelessly.

Client software and databases for implementing the invention may be accessed by the controller/processor 110 from memory 120 or through the database interface 140, and may include, for example, database applications, word processing applications, the client side of a client/server application such as a billing system, as well as components that embody the decision support functionality of the present invention. The computer system 100 may implement any operating system, such as various versions of Windows™ or UNIX, for example. Client and server software for implementing the invention may be written in any programming language, such as ABAP, C, C++, Java or Visual Basic, for example.

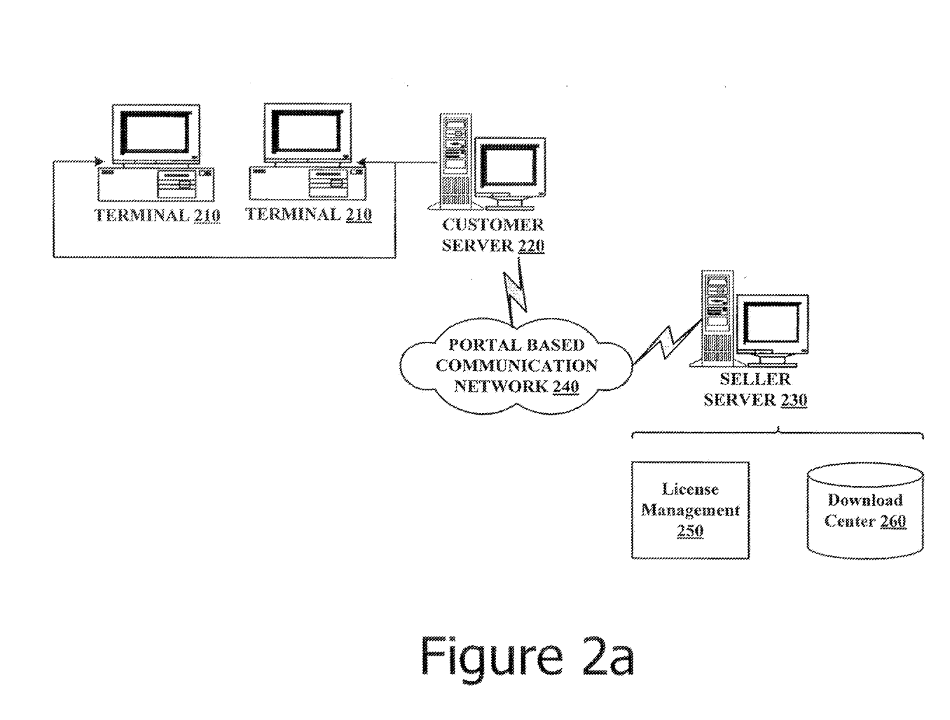

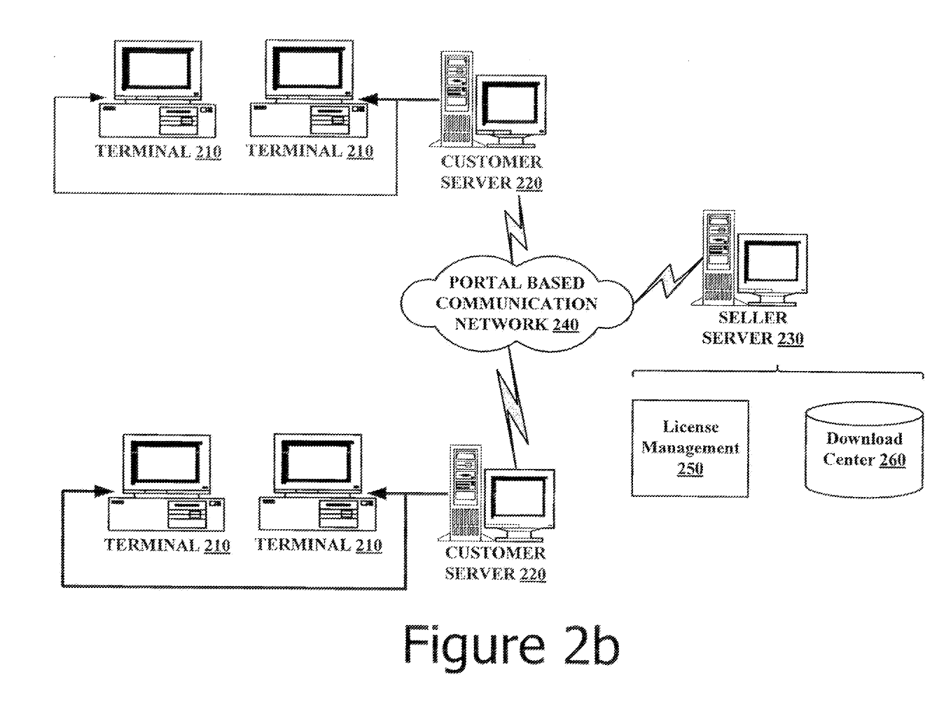

FIGS. 2a-b illustrate embodiments of a system that may be used to implement the present invention. A terminal 210 operated by a customer may access an onsite license server 220. The onsite license server 220 may then access a seller license server 230 via a portal based communication network 240. The seller license server 230 may be running a license manager 250 to store representations of independent software products that may be stored at a software download center 260. These representations may include such data as descriptions of the individual software products, pricing for the individual software products, licensing associated with the individual software products, historical data, future planned upgrades, specifications on how to use the individual software products, the seller's representative responsible for oversight of the software product, or any other information associated with the software product. The license manager 250 may provide all functionality necessary for a licensee to select and license various software applications. The download center 260 may provide all functionality necessary to transfer software applications to the terminal 210. The license manager 250 may track the user terminal's licenses to use the independent software products and control a customer's ability to use software products. The license manager 250 may also control access to the individual software products stored at the software download center 260.

In one embodiment, the download center 260 may include a remote system tracking software application when the customer downloads the licensed products to the user terminal 210. This remote system tracking software application may connect with the server 220 to create a session with the license manager 250, communicating with the license manager once an audit has been performed upon the user terminal 210. Alternatively, the license manager 250 may audit the user terminal 210 each time the customer attempts to download a software product from the download center 260. In one embodiment, tracking functionality may be included as a class in each of the software products.

FIG. 2a illustrates a simple customer environment. One customer license server may be connected to a set of one or more terminals. The terminals 210 may house the software, and the server 220 may house the licenses. Alternately, the software and the licenses may reside within the same machine. In one embodiment, a seller runs the application from the customer license server 220. The customer license server 220 may scan the connected terminals 210 for software covered by the seller's license. The customer license server 220 may connect with the seller licensing server to get any appropriate software applications based on the licenses on the server not present at the customer site. These software applications may be downloaded and installed on customer terminals 210.

FIG. 2b illustrates a complex customer environment. In a complex customer environment, the customer site may have multiple license servers 220, spread across the world and interconnected with the corporate or a leased network, with a set of terminals 210 connected to each customer license server 220. The terminals 210 may house the software, and the server 220 may house the licenses. Alternatively, the software and the licenses may reside within the same machine. In one embodiment, a seller runs the application from the customer license server 220. The customer license server 220 may scan the connected terminals 210 for software covered by the seller's license. The customer license server 220 may connect with the seller licensing server to get any appropriate software applications based on the licenses on the server not present at the customer site. These software applications may be downloaded and installed on customer terminals 210.

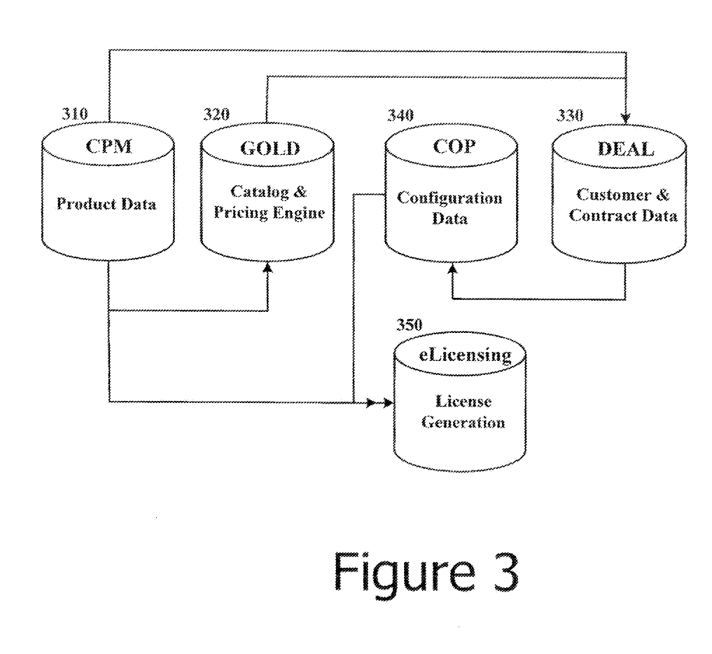

FIG. 3 illustrates one embodiment of a data structure of the license manager. A product master database (PMD) 310 stores the product master data and pricing master data of the seller. A global on-demand license database (GOLD) 320 stores a catalog of price quotes and accounts. The price for a specific software product may vary from customer to customer, with GOLD 320 tracking each price variation. A deal database 330 manages contracts with customers and processes subscription orders, tracking the terms agreed upon in the deal between the customer and the seller. These terms may vary from customer to customer and product to product. A customer owned product (COP) database 330 manages licenses between the customer and the seller, tracking the products licensed or to be licensed by the customer and the period for which those licenses apply. An electronic licensing database 350 takes the licensing data from the COP database 340 and PMD 310 to generate a license to the customer.

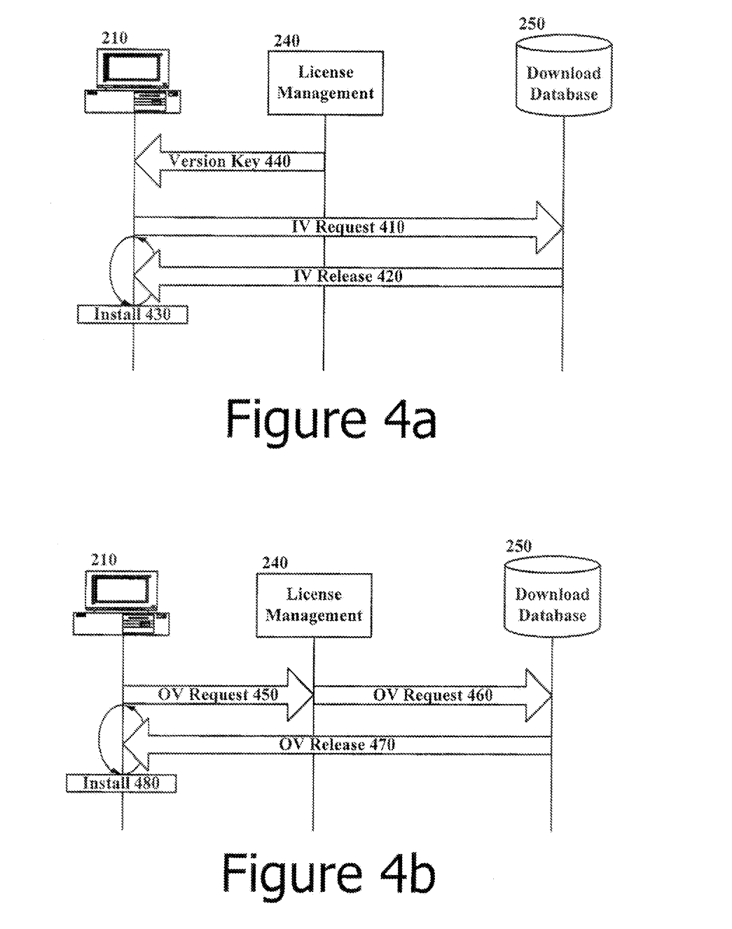

FIG. 4a illustrates one embodiment of transferring the independent software product from the seller to the customer once the license has been established. A user terminal 210 may send a request 410 for inoperable versions to the download center 260. Inoperable versions will not execute properly without some further step being taken by the user, such as the use of a version key. The download center 260 may send a release 420 of the inoperable versions to the user terminal 210. These inoperable versions may then be installed 430 in the terminal 210. The license manager 250 may send a version key 440 to the user terminal 210 once a license between the customer operating the user terminal 210 and the seller operating the server 420 has been established. The version key may be time limited so that the software only works during the time of the license. In one embodiment, the inoperable versions are binaries, and the keys for unlocking the inoperable binaries are binary keys. Here, “binaries” may refer to the working components of the software product. Alternatively, the versions may refer to text files, data files, or other types of software products.

FIG. 4b illustrates an alternate embodiment of transferring the independent software product from the seller to the customer once the license has been established. A user terminal 210 sends a request 450 for the operable versions to the license manager 250. Operable versions do not require a further step being taken by the user in order to execute properly. The license manager 240 forwards the request 460 to the user terminal 210 once a license between the customer operating the user terminal 210 and the seller operating the seller license server 230 has been established. The download center 260 sends a release 470 of the operable versions to the user terminal 210. The operable versions may be time limited so that the software only works during the time of the license. These operable versions may then be installed 480 in the terminal 210. Other systems, that allow controlled access to the software system and take into account licensing provisions, may also be used for distributing the software.

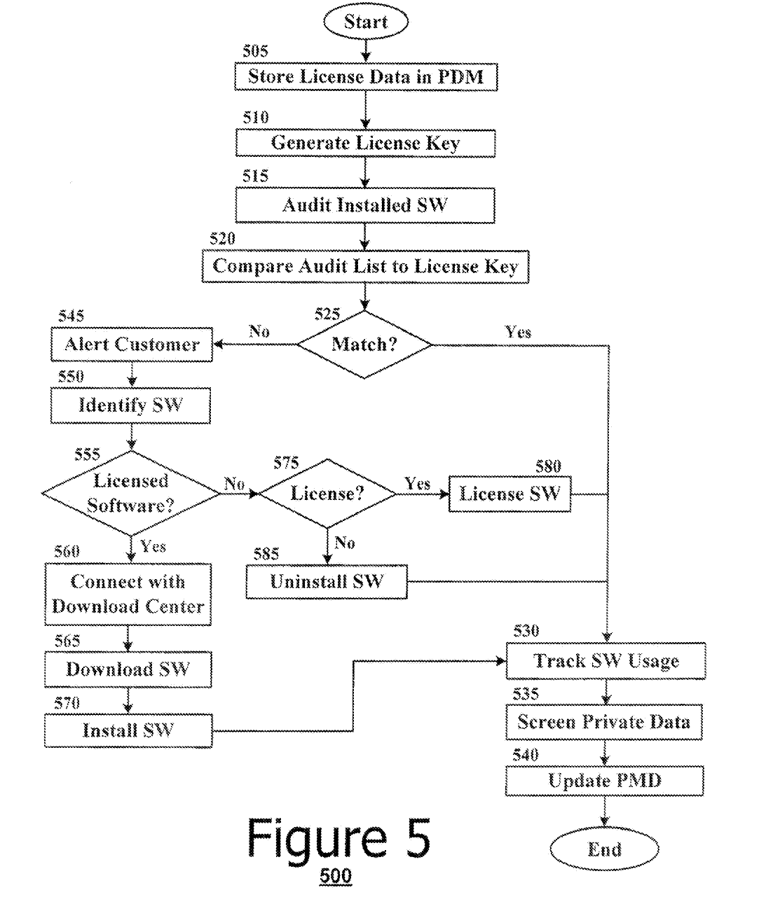

FIG. 5 illustrates in a flowchart one embodiment of a method 500 for automatically detecting software on a customer's terminal that does not conform with the licensing for that customer. The license manager 250 may store licensing data for the software products (SW) in the PMD 310 (Block 505). For a given customer site, the license manager 250 may generate a license key listing the SW products licensed to that customer (Block 510). The license manager 250 may audit the SW products present or installed at the customer site (Block 515). The license manager 250 may compare the audit list to the license key (Block 520). If the audit list matches the license key (Block 525), the license manager 250 may track the current usage of the SW at the customer site (Block 530). A privacy screen may be maintained to screen out private data (Block 535) and the PMD may be updated (Block 540). The private data may be any personally identifiable data of the customer. The privacy compliant use data may then be used for product improvement, pricing, or other uses. If the audit list does not match the license key (Block 525), the license manager 250 may alert customers to the discrepancy (Block 545). The license manager 250 may identify the SW that is the cause of the discrepancy (Block 550). If the discrepancy is that the customer has license for SW not present at the customer site (Block 555), then the customer may be connected with the download center 260 (Block 560). The SW may be downloaded (Block 565) and installed (Block 570), and then the SW tracking process may begin (Block 530). If the discrepancy is that the customer has unlicensed SW present at the customer cite (Block 555), then license manager 250 may offer the customer a license for the unlicensed SW (Block 575). If the customer wants a license (Block 575), the SW may be licensed (Block 580), and then the SW tracking process may begin (Block 530). If the customer does not want a license (Block 575), the SW may be uninstalled or deleted (Block 585), and then the SW tracking process may begin (Block 530).

As noted previously, the foregoing description of embodiments of the invention pertained to licenses for software products. However, those skilled in the art will understand that, using the invention, it also is possible to track licenses for hardware products as well. A customer would not download hardware products, and hardware products would not be made available in the license manager. However, the inventive method would access a customer site and identify the hardware in use at that site, per the unique IDs that hardware has (be it a computer, a peripheral, or the like). In this manner, it is possible to check a license or lease for a hardware product to see whether the license or lease is current, or whether the customer site properly has the licensed/leased hardware product installed there. The license manager, and tracking software at the customer site, would work similarly to what has been described with respect to the software product embodiment to identify hardware at the site. The user at the site would be offered hardware upgrades, for example, if new hardware became available, or would be advised to renew a license or lease of a hardware product installed at the site.

In the above description, for purposes of explanation, numerous specific details are set forth in order to provide a thorough understanding of the present invention. It will be apparent, however, to one skilled in the art that the present invention can be practiced without these specific details.

What is claimed is:

1. A method comprising:
storing, with a license manager, contract data indicating a customer and one or more computer products licensed to the customer by a license holder; and
automatically checking a customer site for present computer products owned by the license holder to determine whether there are any discrepancies between licensed computer products and present computer products.

2. The method of claim 1, wherein said licensed computer products and present computer products include software products.

3. The method of claim 1, further comprising alerting the customer to any discrepancies between licensed computer products and present computer products.

4. The method of claim 1, further comprising maintaining a privacy screen between the license holder and the customer.

5. The method of claim 1, further comprising tracking usage of the present computer products by the customer.

6. The method of claim 1, further comprising allowing a customer to purchase a license for an unlicensed present computer product.

7. The method of claim 1, further comprising deleting an unlicensed present computer product.

8. The method of claim 1, wherein the customer site is a complex customer environment.

9. A set of instructions residing in a storage medium, said set of instructions capable of being executed by a processor to implement a method for processing data, the method comprising:
storing, with a license manager, contract data indicating a customer and one or more computer products licensed to the customer by a license holder; and
automatically checking a customer site for present computer products owned by the license holder to determine whether there are any discrepancies between licensed computer products and present computer products.

10. The set of instructions of claim 9, wherein said licensed computer products and present computer products include software products.

11. The set of instructions of claim 9, further comprising alerting the customer to any discrepancies between licensed computer products and present computer products.

12. The set of instructions of claim 9, further comprising maintaining a privacy screen between the license holder and the customer.

13. The set of instructions of claim 9, further comprising tracking usage of the present computer products by the customer.

14. The set of instructions of claim 9, further comprising allowing a customer to purchase a license for an unlicensed present computer product.

15. The set of instructions of claim 9, further comprising deleting an unlicensed present computer product.

16. The set of instructions of claim 9, wherein the customer site is a complex customer environment.

17. A system comprising:
a license manager to store contract data indicating a customer and one or more computer products licensed to the customer by a license holder; and
a processor to automatically check a customer site for present computer products owned by the license holder, and to determine whether there are any discrepancies between licensed computer products and present computer products.

18. The system of claim 17, wherein said licensed computer products and present computer products include software products.

19. The system of claim 17, wherein the customer is alerted to any discrepancies between licensed computer products and present computer products.

20. The system of claim 17, wherein a privacy screen is maintained between the license holder and the customer.

21. The system of claim 17, wherein the tracking software program tracks usage of the present computer products by the customer.

22. The system of claim 17, wherein a customer is allowed to purchase a license for an unlicensed present computer product or to delete the unlicensed present computer product.

23. The system of claim 17, wherein the customer site is automatically checked via a network.
